(19) United States
(12) Patent Application Publication
(10) Pub. No.: US 2019/0286414 A1
(43) Pub. Date: Sep. 19, 2019

(54) VOICE ACTIVATED VISUAL COMMUNICATION SYSTEM

(71) Applicant: GEOFFREY LANGOS, Philadelphia, PA (US)

(72) Inventor: GEOFFREY LANGOS, Philadelphia, PA (US)

(21) Appl. No.: 16/353,005

(22) Filed: Mar. 14, 2019

Related U.S. Application Data
(60) Provisional application No. 62/645,136, filed on Mar. 19, 2018.

(51) Int. Cl. G06F 3/16; G06F 3/14; G10L 15/18; G10L 15/22; B60Q 1/50; B60R 16/037

(52) U.S. Cl. CPC G06F 3/167; G06F 3/1423; B60R 16/0373; G10L 15/22; B60Q 1/503; G10L 15/18

(57) ABSTRACT

A voice actuated visual communication system for a driver of a vehicle in traffic to communicate visually with drivers of other vehicles in proximity to his or her vehicle for, among other things, driving safety.

### CROSS REFERENCE TO RELATED APPLICATION

This application claims priority from U.S. Provisional Application No. 62/645,136 filed on Mar. 19, 2018.

### FIELD OF THE INVENTION

The instant invention relates to a system that allows the driver of a vehicle in traffic to communicate visually with drivers of other vehicles in proximity to his or her vehicle with the purpose being, among other things, driving safety.

### BACKGROUND OF THE INVENTION

Currently, there are limited methods for motor vehicle drivers in close proximity to each other to communicate with each other. Motor vehicles are limited to apparatuses such as turn signals, horns, tail lights, and headlights. The system of the present invention allows a driver to provide additional information in communicating visually with other drivers, such as intent, sentiment, suggestions, gestures, and reasoning in order to improve safety, respond to courteous actions, and make driving more enjoyable.

### SUMMARY OF THE INVENTION

The processing system of the present invention includes certain components, including, in certain embodiments, the following: single, multiple, or dual sided, monochrome or full-color, illuminated screens, using LEDs, organic light-emitting diode (OLED) screens, small screens, stick-on transparent screens, projected images on windows or projected images into space, as well as Retina Displays, of any size mounted anywhere on any type of motor vehicle; a microphone; an operating system controlling said processing device; a rules engine; an optional timer; a speech recognition engine; natural language and inflection detection software; a speech-to-text engine; an in-memory database; certain mounting devices; one or more speakers; a port to connect to a PC via USB; a hard-wired internet port; Wi-Fi, Bluetooth, Broadband Wireless, and GPS capabilities; configuration and security software; Cloud architectures; and a power source, such as a battery with a numerous charging methods, to form a system that takes commands from a driver, matches them to images in the database or translates them to text, and displays one or more images to other drivers, providing them a visual message that could include a user/driver's intent, a response to a courteous action, a suggestion, or any number of visual messages.

Before this invention, drivers were limited to using apparatuses found on most motor vehicles, such as turn signals, tail lights, reverse lights, headlights, or horns to communicate with other drivers in close proximity to them. Some drivers also waive their hands, use their fingers to point, open a window and speak, blink their headlights, install bumper stickers, or install, as shown in Prior Art Fig. A, in the rear window 1A of a vehicle 2A small signs that give other drivers more information, such as static sign 3A “Baby on Board” as shown in Prior Art Figure A.

This invention allows a system user/driver to provide infinitely more information to other drivers around him or her by, as shown in FIG. 1, installing by use of fasteners 11 an electronic display screen 10, selected from the group of screen displays described hereinabove, in the rear window of his or her motor vehicle to display a message generated by the driver's voice telling the system to display an image 101, such as the message “U-turn” visible to any vehicle trailing said user/driver's vehicle. FIG. 2 shows a similar display 10 signaling an image 102 for the message “May I please get over” for a user/driver attempting to merge to the right; similarly, FIG. 3 shows a display 10 for signaling an image 103 for the follow up message “Thank you” after user/driver having safely merged right into traffic. As shown in FIG. 2X, screen 10 can be constructed so as to include a screen 10X on its reverse side to show the same image 102 inverted 180-degrees on the x-axis, commonly known as “Mirror Writing”, to give the system user/driver of the vehicle a visual confirmation of said message 102 that can be read correctly in a rearview mirror, displayed as message 102X on screen 10X. This embodiment using a screen 10X can also be used by system user/driver by installing said screen on his or her front windshield so that drivers in close proximity that are leading his or her vehicle can read a message such as 102X correctly in a rearview mirror.

As described herein, the processing system of the present invention can include numerous predefined command-image combinations installed in software during the manufacturing process that will account for a panoply of obvious driving situations so that user/drivers can use it right out-of-the-box with no additional configurations needed, but the preferred embodiment of the system is user programmable by way of application software that can be installed on a computing device to allow a user/driver to upload a customizable image, such as image 104 on screen 10 in FIG. 4, an image programmed by a user to be displayed on a unique voice command, such as “Flirt.”

### BRIEF DESCRIPTION OF THE DRAWINGS

Fig. A illustrates prior art communication technology between vehicles in traffic.

FIG. 1 depicts a screen display of the present invention as seen from the rear window of a vehicle.

FIG. 2 depicts a screen display of the present invention as seen from the rear window of a vehicle.

FIG. 2X depicts a screen display of the present invention as shown in FIG. 2 as seen from the front of a vehicle.

FIG. 3 depicts a screen display of the present invention as seen from the rear window of a vehicle.

FIG. 4 depicts a screen display of the present invention as seen from the rear window of a vehicle.

FIG. 5 is a block diagram of the high level components of the system of the present invention as configured by a user/driver and as used by a user/driver.

FIG. 6 is a block diagram of certain components of the processing system of the present invention.

FIG. 7 shows an embodiment of the system of the present invention using screens in multiple dimensions as seen from the rear or side of a vehicle equipped with the system of the present invention.

FIG. 7X shows the embodiment of the system of the present invention of FIG. 7 as seen from the perspective of the user/driver of a vehicle equipped with the system of the present invention.

FIG. 8A is a flowchart for the timer function of the system of the present invention.

FIG. 8B illustrates the ability of a user/driver to override the timer function of FIG. 8A.

FIGS. 9.1, 9.2, and 9.3 illustrate the use of the system of the present invention in commercial transit, respectively, a bus, an airplane, and a truck.

### DETAILED DESCRIPTION OF THE INVENTION

Motor vehicles are ill-equipped to provide a driver with a way to inform other drivers in close proximity of his or her intent, sentiment, suggestions, thoughts, or feelings. That problem is solved by the invention described herein, to wit, a system that allows drivers to use voice commands to display an infinite number of visual signals to other drivers. This will improve driving safety, allow drivers to “personalize” their motor vehicle, reduce the stress of driving, especially in high traffic situations, project his or her feelings, and promote courteous and safe driving.

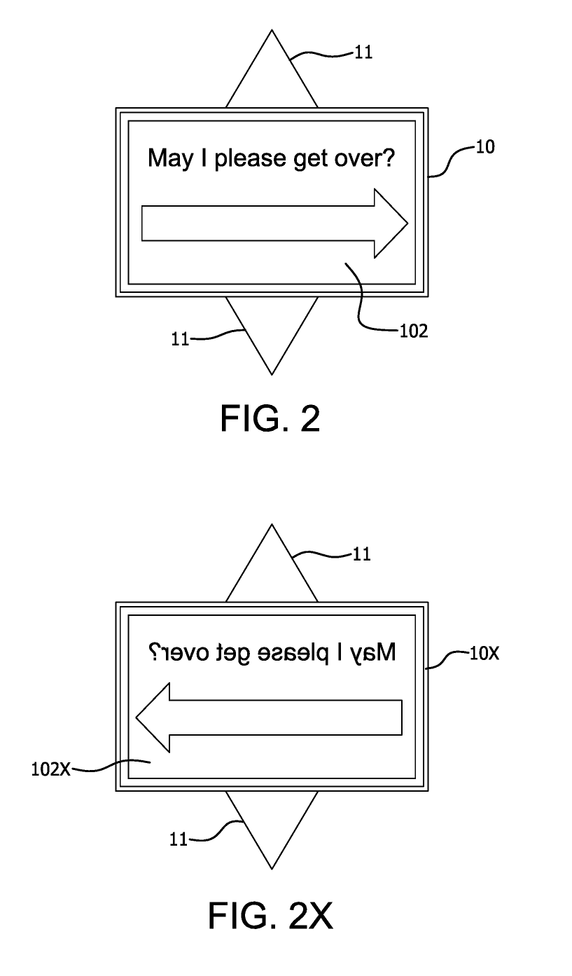

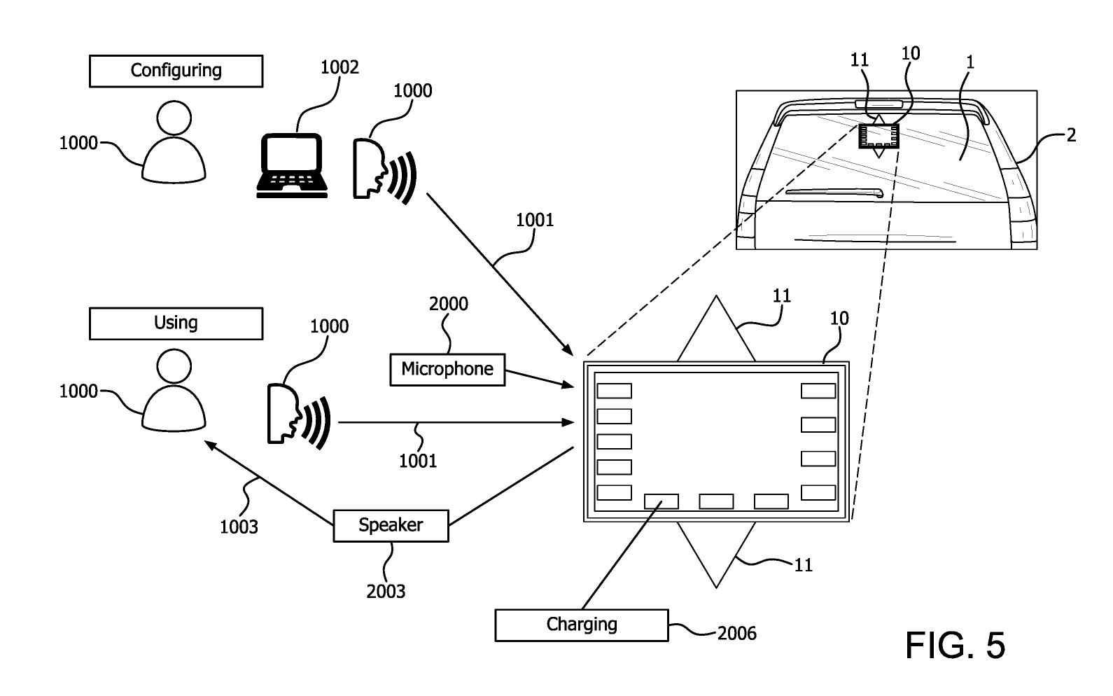

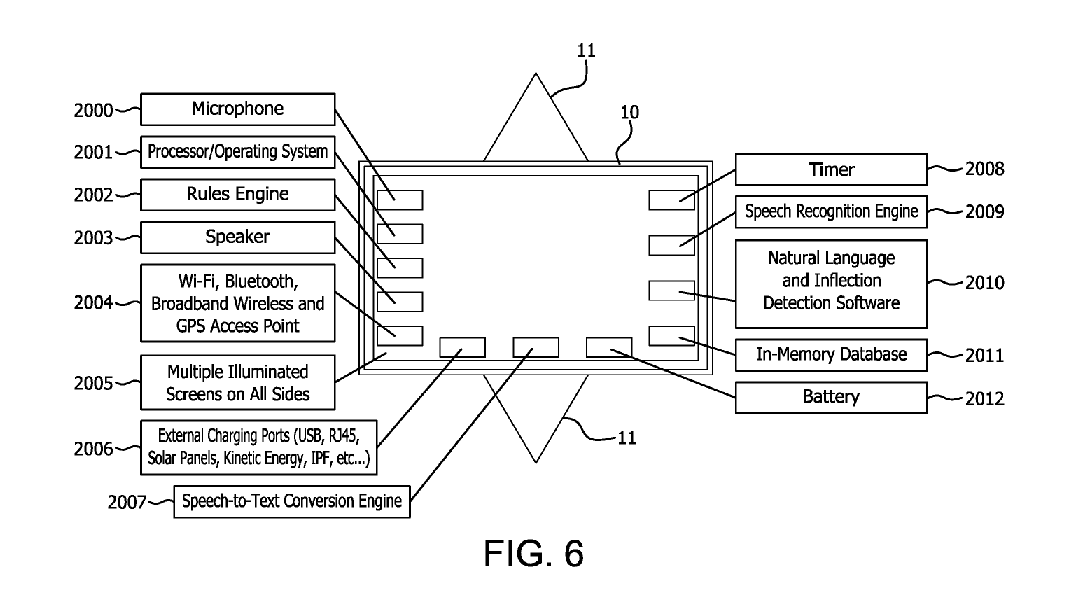

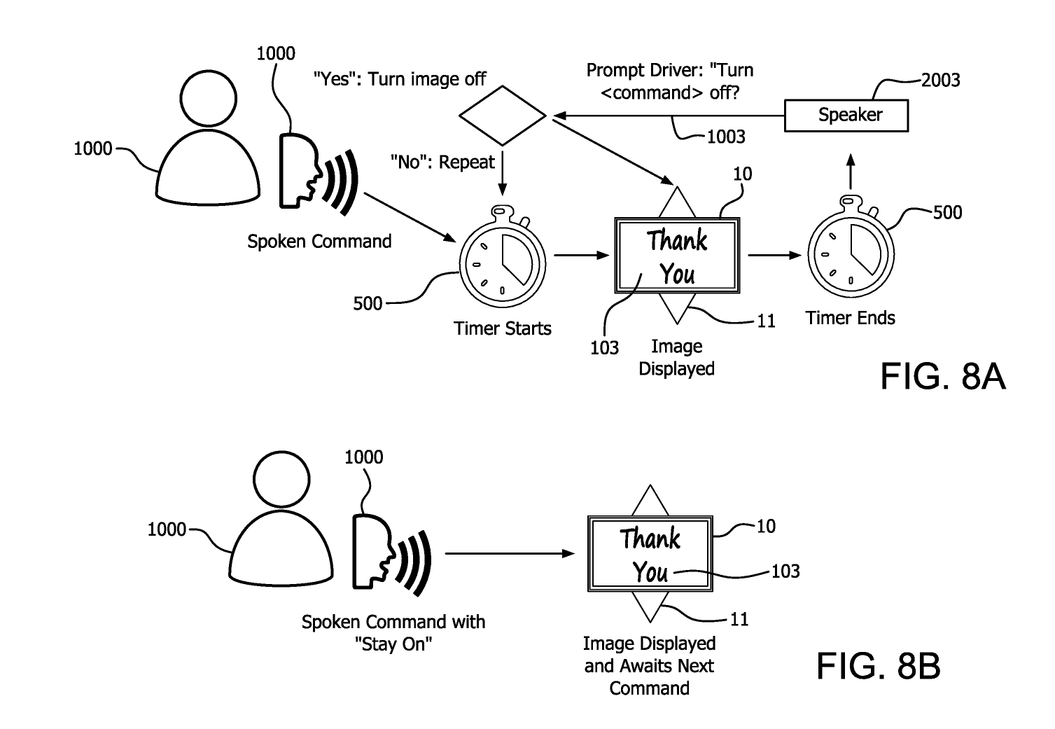

Referring to FIG. 6, certain technologies as shown in the block diagram, including, but are not limited to, open-source speech and voice recognition software such as Kaldi™ software, Mozzilla™ Foundation software, and CMU Sphinx™ software, as referenced in block 2009; a microphone 2000 and at least one speaker 2003; LED and OLED screens, as well as each of the screen technologies and projection technologies set forth hereinabove, as referenced in block 2005; in-memory databases, as referenced in block 2011; open source natural language processing engines such as Apache™ Software Foundation software, such as OpenNLP, as referenced in block 2010; suction cups on fasteners 11 for adhering screen display 10 to a window of a vehicle, such as rear window 1 as shown in FIG. 5; optional timing circuitry, as referenced in block 2008; an operating system (OS) 2001 controlling a processing device and used in conjunction with a rules engine 2002, using artificial intelligence (AI) and machine learning (ML) software which encompasses a manual and automated screen holding system, configuration and security software, such as passphrase and password protection algorithms; a speech-to text conversion engine 2007; broadband wireless data technologies for cloud access, such as the standards known as 3G, 4G, LTE, CDMA, BS Bluetooth®, Wi-Fi technology, and GPS (global positioning satellite technology), as referenced in block 2004; and rechargeable batteries 2012 and battery charging apparatuses, as referenced in block 2006; can be used as component technologies of the system of the present invention in the following manner: voice input is received by microphone 2000 having an output connected to the input of speech recognition engine 2009, with an output processed by natural language and inflection detection software 2010 to provide an input to rules engine 2002, controlled though OS 2001, whereby a preprogrammed message stored in database 2001 is generated as an input to one of a panoply of screens 2005, such as screen display 10, in order to display a visual message, such as “May I get over?” 102 in FIG. 2, or, in the case in which the output of rules engine 2002 is not matched with a preprogrammed message, said output is processed by speech-to-text engine 2007 in order to generate a visual message for display on, for example, screen display 10. Said processing system is powered by battery 2012, which may be recharged by external charging ports 2006, and may be configured for connectivity to other devices, and the cloud, through one or more of the technologies referenced in block 2004, and may power speaker 2003 for audible feedback as to messages displayed on screen 10 to user/driver 1000. Optional timing circuity, referenced in FIG. 6 as timer 2008, may be used to govern the period of time that a message remains visibly displayed on said screen 10 as further described below in connection with the description of FIG. 8A in which the element of timing circuity is set forth therein as timer 500.

Once the system of the present invention has been powered up for the first time, as shown in FIG. 5 the user/driver 1000 has the option (i) to allow the system to be commanded by the use of any voice, similar to breadth of command in the Amazon® Alexa® system, or (ii) to set up specific voice recognition, which will then allow only the user's voice to control this instantiation of the system without the driver's voice being used to change, override, or reset the voice recognition. This feature can be changed by the user/driver 1000 by using voice commands or otherwise by configuring the system software using a laptop 1002 as shown in FIG. 5 (or another processing device, such as a desktop computer or smartphone). Protection mechanisms such as these prevent the use of the system by anyone other than the user/driver, rendering the device useless to anyone else or to passengers in the vehicle in which the system is installed, further promoting safety.

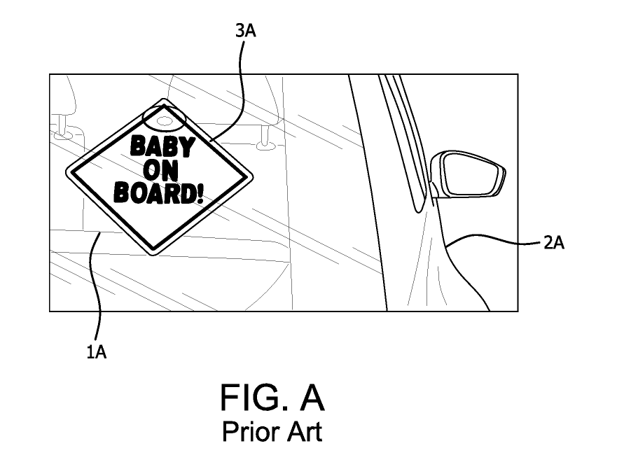

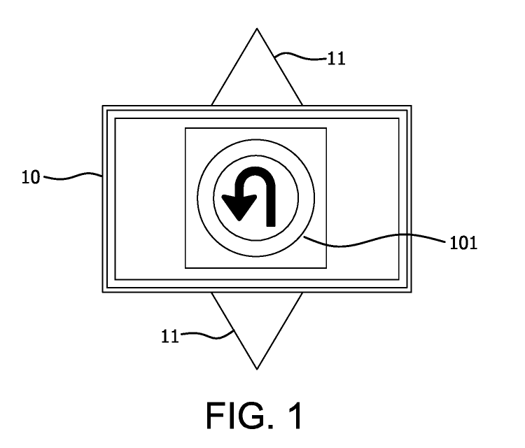

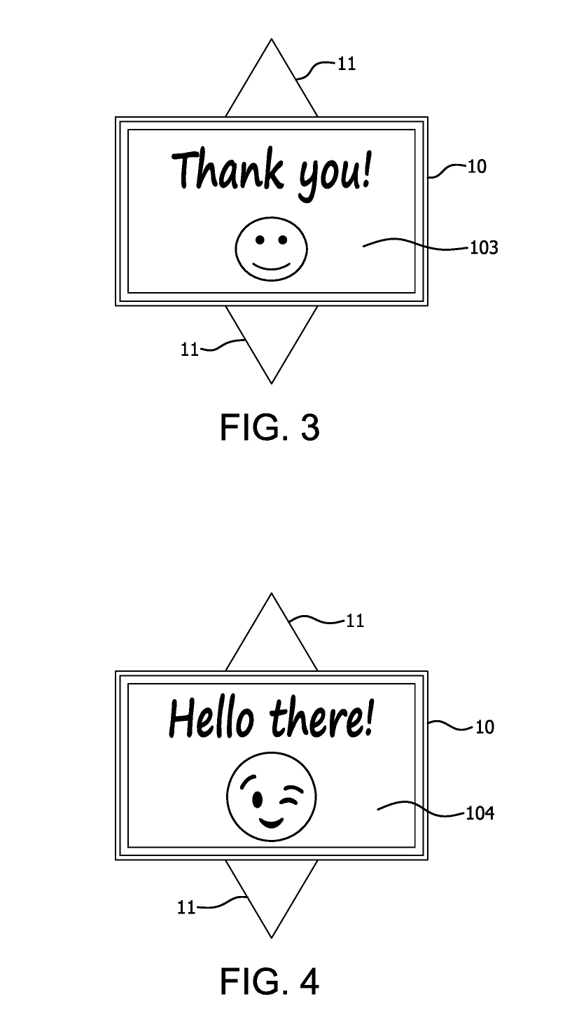

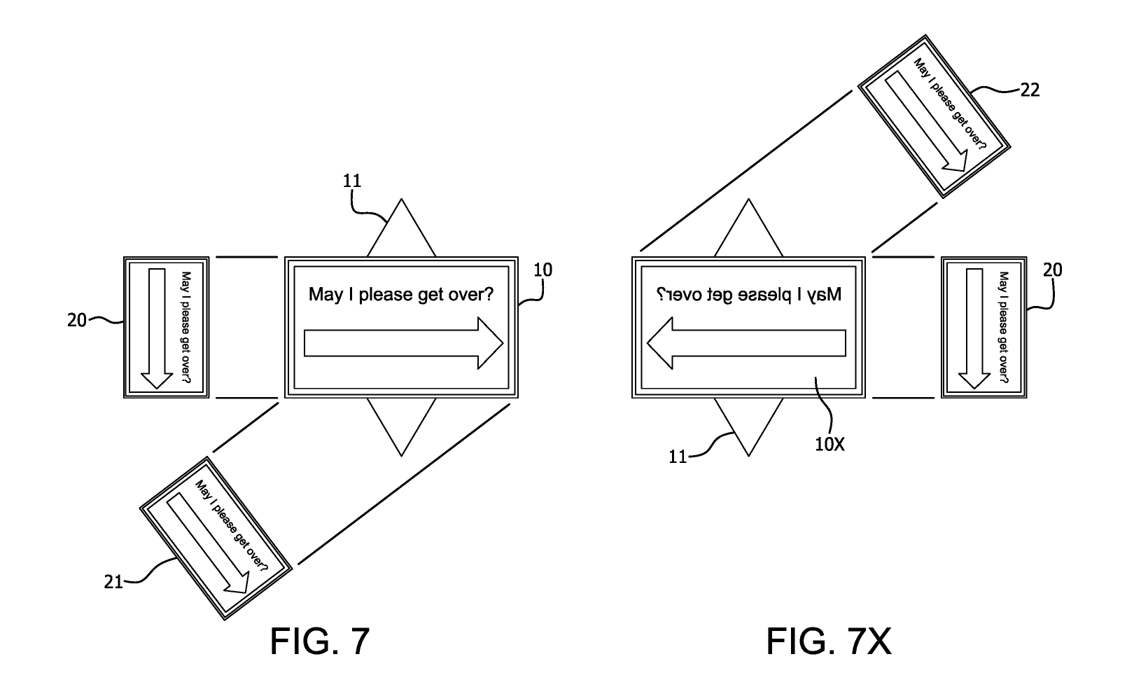

User/driver 1000 configures the system and installs the screen display 10 of the system anywhere on a vehicle using a mounting device 11 provided as shown in FIGS. 1 through 8. The “Configuring” block diagram of FIG. 5 shows screen display 10 installed in the rear window 1 of vehicle 2 using fasteners 11 and being charged through an external charging port 2006, configured by use of laptop 1002 as explained above. The “Using” block diagram/flowchart of FIG. 5 depicts basic operation of the system as user/driver 1000 speaks a voice command 1001 into microphone 2000 which voice command 1001 controls the operation of the system as described herein. In the preferred embodiment of this invention, FIG. 5 shows speaker 2003 providing an audible message 1003 as feedback, or as an alert, to user/driver 1000 as described herein. Referring to FIG. 7 and FIG. 7X, an articulated arm (not shown) may be employed to move or reposition a screen display, such as display 10 in FIG. 7, from the back window to a side window (as in display 21) or from a front window (such as display 10x in FIG. 7X) to a side window (as in display 22). In FIG. 7, an embodiment of the system shows a second screen display 20 located on a side window of the equipped vehicle that makes visible the same message 102 to drivers motoring next to the equipped vehicle as the message 102 that is visible to drivers following said vehicle on screen 10; similarly, in FIG. 7X, additional screen display 20 alerts drivers next to said vehicle to the same message 102 that a user/driver reads as message 10X but understands correctly as it appears in his or her rear view mirror. Having installed the system of the present invention, as shown in FIG. 5, driver 1000 can use predefined, or custom-defined, vocal commands 1001 by first initializing the system by speaking the password, or wake up word, such as, for example, the name “Betsy,” followed by a command, such as, “Betsy, U-Turn!” In the preferred embodiment of the present invention as shown in FIGS. 8A and 8B, a spoken command causes “Thank you” image 103 to be displayed on screen 10 and at the same time sets timer 500. Timer 500 can be programmed by user/driver 1000 using system software to regulate that time period that such “Thank you” image 103 remains displayed. As shown in FIG. 8A, the period of time during which image 103 is visibly displayed may be set, or preprogrammed, in the software platform of the system as a default setting, for example, the default setting may be set at 30 seconds; however, such default may be overridden as described hereinbelow, or may be changed as such software is configurable by user/driver 1000 to yield a different period for display, such as, for example, one minute. An example of manual override of the default timer setting is shown in FIG. 8B as driver 1000 overrides the timer using the voice command “Stay on” after speaking the initial voice command for the image 103 “Thank you.” In that case, as shown in FIG. 8B, image 103 remains displayed on display 10 indefinitely while the system awaits the next voice command from driver 1000. Alternatively, user/driver 1000 can override the default timer setting with an initial voice command such as “Betsy U-Turn for 1 minute,” which would keep the image 101 in FIG. 1 displayed for one minute regardless of the default setting programmed in software. The system of the preferred embodiment is configured such that, when timer 500 is about to terminate image 103 signaling “Thank you” in FIG. 8A, user/driver 1000 may be prompted by voiced query from speaker 2003 as to whether image 103 should be turned off immediately, or whether the system turn the current image off as per the default setting; as shown in FIG. 8A, if driver 1000 responds with voice command “No,” then timer 500 resets and the process repeats until the driver responds with voice command “Yes.” Additionally, and similarly to the override shown in FIG. 8A, the system is programmed to allow user/driver 1000 to use a voice command at any time to keep an image on indefinitely by saying a phrase such as “Keep on,” which will keep the current image displayed until the driver says a new command. At every potential change in state of the system, the user/driver can be provided an audible confirmation 1003 from speaker 2003 in FIG. 5, such as, “Keeping U-turn on for 1 minute,” or “U-turn is off.” Additionally, if no image in the library of prepared images in database 2011 corresponds to, or is matched with, a given voice command, the system in the preferred embodiment uses speech-to-text engine 2007 to create an image of the driver's command in real-time. The preferred embodiment of the system then confirms this image with driver 1000 by displaying the image in screen 2X which is visible only to user/driver in his or her rear view mirror, and follows the same process as in the flowchart outlined in FIG. 8A.

The power source of the preferred embodiment, rechargeable battery 2012, may select any of the alternatives in element 2006, including, using 12-volt or USB source provided within most motor vehicles, by plugging it into an AC outlet, or by Inductive Power Transfer (IPF), or by attaching an external charging source, or by using solar energy panels or kinetic energy generated by the motor vehicle itself, or by the user/driver or even by one or more passengers. The life of battery 2012 can be preserved by the driver using a voice command such as, “Betsy turn off,” by using the timer to detect no activity, by using GPS to determine the motor vehicle is parked, or by detecting that the motor vehicle engine has been turned off, or by way of other known methods of battery life strategy.

The preferred embodiment of the present system is configured to connect to the internet via Wi-Fi, Local Area Network (by way of RJ-45 or USB), or by using any of the aforesaid broadband wireless technologies, as well to take advantage of locational GPS signals. The present system is not configured to require any connections to any network in order to operate properly in order to deliver valuable service to a user/driver and consequently to third party drivers in close proximity. If external connections are available, the system can be configured to use information provided by them to improve the driver's experience and influence other drivers who as well have installed the same system in their vehicles. For example, if there is a car accident ahead, a user/driver can by voice command inform other drivers in close proximity, and give permission to rebroadcast this to all systems proximately located in the area that may be impacted.

The preferred embodiment of the present system can be configured to “learn” the user/driver's habitual traffic patterns using AI or ML, and suggests images from its database that are used frequently based on the user/driver's location. For example, the system may suggest an image and wait for confirmation, such as, “Do you want to make a U-turn?” based upon the location of the motor vehicle and past history of commands. The user/driver can respond “Yes” to display the recommended image and proceed as per the flowchart in FIG. 8A or “No” (or not at all), in which the system does nothing.

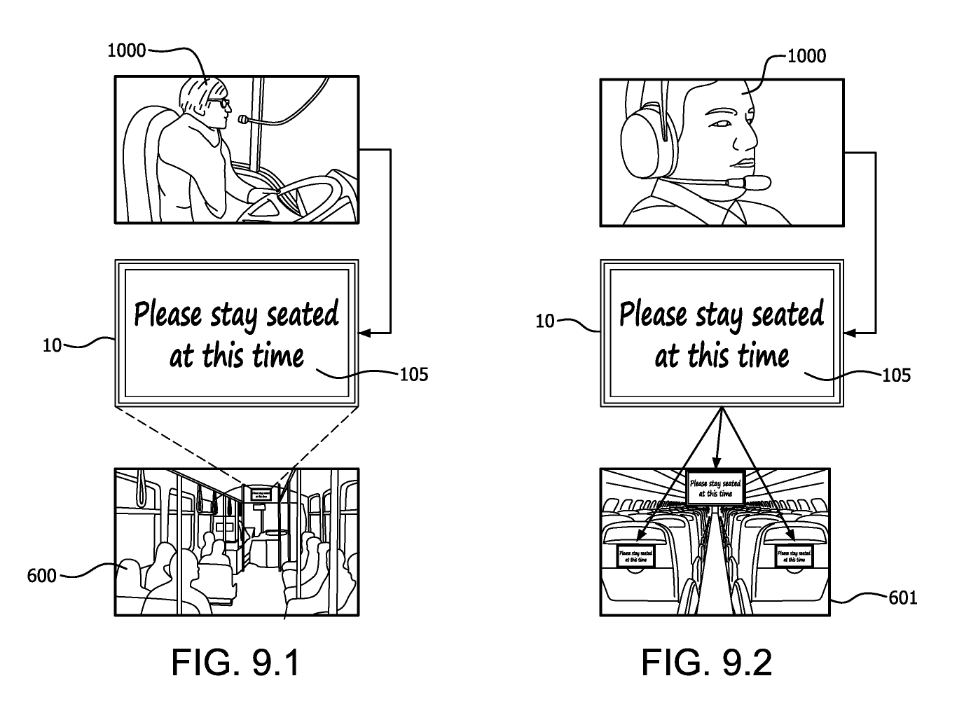

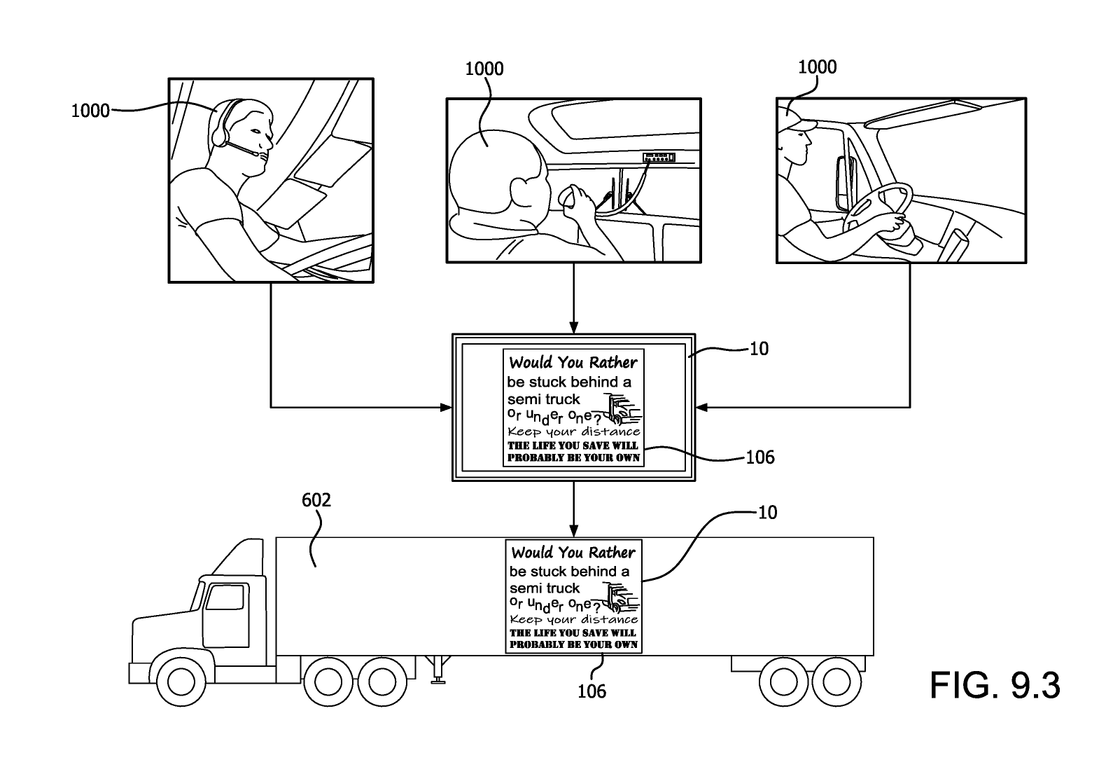

This invention allows a user/drivers to communicate his or her intentions, sentiment, feelings, and suggestions to other drivers in close proximity using visual displays, all controlled by the driver's voice through the easy to use user interface of the present system. The system is susceptible of being mounted anywhere on the user/driver's motor vehicle. The system can be programmed to communicate with multiple instantiations on the same vehicle with a single voice command, allowing the driver to install more than one system on a single motor vehicle. This is especially useful on large motor vehicles such as SUV's, busses, and 18-wheeler trucks where large screens can be installed on the exterior that are controlled by an interior system of the present invention as shown in FIGS. 9.1, 9.2, and 9.3. Additionally, the invention is configurable to alert automatically the user/driver audibly, and other drivers visually, of emergency alerts such as an ambulance, fire engine, or police activity in close proximity. As shown in FIG. 9.3, the instant invention is able to visually display advertisements based on any of the inputs available to it, such as location, user/driver preferences, and endorsements of a user/driver.

With programming and use of the various technologies described hereinabove, the system of the instant invention can receive information regarding traffic signals and traffic patterns in close proximity to it, and consequently alert a user/driver via audible warning and alert other drivers visually of such safety information, or, for example, can be configured to inform a user/driver audibly, and other drivers visually, of the outside temperature and other weather and road conditions. Additionally, the system of this invention can be used to alert drivers visually in close proximity to a student driver car or driverless car of the nature of the vehicle near to them. User/drivers, as well as drivers in close proximity to a vehicle incorporating the system of the present invention, can connect to such system to access emails, texts, Snap-Chat messages, and other notifications without taking their eyes off the road.

This invention can provide a user/driver's information about the use of the device to insurance companies for potential safe driving discounts. As shown in FIGS. 7 and 7x, the system may include multiple large or small illuminated screens that can be installed on the driver's side view mirrors, as well as the rear window or passenger window, for additional visibility to other drivers in close proximity. This system can be programmed to assist in sending feedback to websites such as Yelp based on the location of the driver and can audibly solicit a user/driver's feedback and use speech-to-text to translate the feedback and upload it to a website with full text and rating.

As shown in the block diagram of FIG. 6, the preferred embodiment of the system of the present invention is composed of full-color illuminated screen, a microphone, an operating system, a rules engine, a timer, a speech recognition engine, natural language and inflection detection software, an in-memory database, a mounting device, a speaker, a port to connect to a PC via USB, a hard-wired internet port, Wi-Fi, Bluetooth®, broadband wireless, and GPS capabilities, configuration and security software, Cloud architectures, and a battery with a numerous charging capabilities.

The system of this invention can be configured in order to satisfy multiple commercial uses, such as in busses, trains, metro vehicles, airplanes, and trucks, in that, as shown in FIGS. 9.1, 9.2, and 9.3, the system can be installed in front of passengers to give visual information from the driver of a bus or the pilot of an airplane, or to assist hearing-impaired passengers or to provide a quieter environment by allowing the driver or pilot to speak in natural language and have visual images of the messages to be displayed. Installation of the inventive system on trucks can facilitate advertisements or information about the trucking company as shown in FIG. 9.3.

The breadth of the present invention is not to be limited to the examples provided and/or the subject specification. The preferred embodiment as described herein should not be viewed as a limitation on the scope of the invention covered hereby, coverage of which hereunder shall include the many variations explicitly or implicitly described herein.

What is claimed is:

1. A message signaling system for use by the driver of a vehicle comprising:
a microphone located in said vehicle to receive voice commands from said driver;
a processing device controlled by an operating system and running a program having an input from the output of said microphone;
a first screen display attached to a window of said vehicle having an input from the output of said processing device; and
a power supply connected to and providing electrical power to said processing device and said screen display,
whereby said program controls the input of said screen display as a function of the output of said microphone with the result that an image matched with said voice commands of said driver is displayed thereon as a visual message to drivers of vehicles in close proximity to said vehicle.

2. The system of claim 1 wherein said first screen display is attached to the rear window of said vehicle in a manner so that said message is visible to drivers of vehicles following said vehicle.

3. The system of claim 2 in which said first screen display further comprises a second screen display displaying said image so as to be visible to and readable by said driver of said vehicle in the rearview mirror of said vehicle.

4. The system of claim 1 further comprising timing circuitry powered by said power supply and connected to the input of said screen display
whereby the period of time that said message is visible is governed by said timing circuitry.

5. The system of claim 1 further comprising: a speaker powered by said power supply and having an input from the output of said processing device,
whereby said speaker provides audible messages to said driver in connection with said driver's voice commands and said visual messages displayed in response to said voice commands.

6. The system of claim 5 in which such audible messages are selected from the group comprised of prompts, queries, and feedback.

7. The system of claim 1 in which said program comprises:
a speech recognition engine;
natural language and inflection detection software;
an in-memory database; and
a rules engine.

8. The system of claim 5 in which said program comprises:
a speech recognition engine;
natural language and inflection detection software;
an in-memory database;
a rules engine, and
a speech to text conversion engine.

9. The system of claim 8 in which such audible messages are selected from the group comprised of prompts, queries, and feedback.

10. The system of claim 1 in which said power supply is a rechargeable battery.

11. The system of claim 10 further comprising external charging ports by which said battery may be charged selected from the group comprised of a USB port, an RJ45 port, an inductive power transfer port, and a 12 volt DC port.

12. The system of claim 11 in which one of said ports is connected to a power source selected from the group of a 12 volt automotive battery, an AC power supply, an inductive power supply, an electrical source powered by solar energy, and an electrical source powered by automotive kinetic energy.

13. The system of claim 1 further comprising at least one screen display in addition to said first screen display, each of which additional screen displays having an input from the output of said processing device and receiving electrical power from said power supply.

14. The system of claim 3 in which said image displayed on said second screen display is said image displayed on said first screen display inverted 180 degrees on its x-axis,
whereby said message displayed on said second screen display is visible to and can be correctly read by said driver in the rearview mirror of said vehicle.

15. The system of claim 14 in which inverting said image is mirror writing.

16. The system of claim 4 in which the input to said timing circuitry is connected to the output of said program,
whereby said timing circuitry can be overridden by voice command of said driver so that the period of time that said message is visible is governed by said voice command.

17. The system of claim 1 further comprising means to connect said processing device to an external network.

18. The system of claim 17 in which said external network is selected from the group comprising the internet, a local area network, or the global positioning system.

19. The system of claim 17 in which said connecting means is selected from the group comprising Wi-Fi, Bluetooth®, and broadband wireless.

20. A method to provide a visual message to drivers in close proximity to the driver of a vehicle comprising the steps of:
speaking a message into a microphone;
using speech recognition software to analyze the output of said microphone;
matching the output of such speech recognition software to the entries in a library of images stored in a database;
using a signal corresponding to a matched image as an input to a first screen display attached to a window of said driver's vehicle; and
displaying said image on said screen display
whereby a visual message corresponding to said spoken message is provided to drivers in close proximity to said vehicle.

21. The method of claim 20 wherein said first screen display is attached to the rear window of said vehicle in a manner so that said message is visible to drivers of vehicles following said vehicle.

22. The method of claim 21 in which said first screen display further comprises a second screen display displaying said message so as to be visible to and readable by said driver of said vehicle in the rearview mirror of said vehicle.

23. The method of claim 22 further comprising the step of:
reviewing said image in the rearview mirror of said vehicle.

24. The method of claim 20 further comprising the step of:
listening to audible feedback related to said image.

25. The method of claim 20 further comprising the steps of:
listening to one or more audible prompts related to said image; and
speaking a voice command into said microphone in order to terminate display of or modifying said image.

26. The method of claim 20 further comprising the step of:
modifying said image.

27. The method of claim 20 further comprising the step of:
terminating display of said image.

28. The method of claim 26 further comprising the step of:
terminating display of said image.
